(19) United States
(12) Patent Application Publication
(10) Pub. No.: US 2026/0014765 A1
(43) Pub. Date: Jan. 15, 2026

(54) METHOD FOR PRODUCING TIRE AND TIRE

(71) Applicant: BRIDGESTONE CORPORATION, Chuo-ku, Tokyo (JP)

(72) Inventor: Hiroyuki KATSUNO, Chuo-ku, Tokyo (JP)

(73) Assignee: BRIDGESTONE CORPORATION, Chuo-ku, Tokyo (JP)

(21) Appl. No.: 18/872,933

(22) PCT Filed: May 26, 2023
(86) PCT No.: PCT/JP2023/019789

§ 371 Date: Dec. 9, 2024

(30) Foreign Application Priority Data
Jul. 25, 2022 (JP) 2022-118281

(51) Int. Cl. B29D 30/06; B60C 19/00

(52) U.S. Cl. CPC B29D 30/0681; B29D 30/0606; B60C 19/00; B60C 2019/004

(57) ABSTRACT

The provided is a method for producing a tire to obtain a tire with an electronic device 6 attached to a tire side portion, the method including: an electronic device arrangement process in which the electronic device 6 is arranged in at least one of: the lower mold piece 32, the upper mold piece 33, the vicinity of a tire outer surface 20o of the tire side portion 28 of the raw tire 20 on the side that comes into contact with the lower mold piece 32, and the vicinity of a tire outer surface 20o of the tire side portion 28 of the raw tire 20 on the side that comes into contact with the upper mold piece 33; and a vulcanization process in which the raw tire 20 is set in the mold 31 and vulcanized after the electronic device arrangement process.

### TECHNICAL FIELD

This disclosure relates to a method for producing a tire and a tire.

This application claims priority to Patent Application No. 2022-118281, filed in Japan on Jul. 25, 2022, the entire contents of which are incorporated herein by reference.

### BACKGROUND

There has been known a configuration in which an electronic device such as an RF tag is attached to the vicinity of the outer surface (including the outer surface) of a tire side portion. For example, Patent Document 1 discloses a pneumatic tire having a film-like electronic device attached to the tire surface of the tire side portion.

### CITATION LIST

### Patent Literature

PTL 1: JP 2004-090775 A

### SUMMARY

### Technical Problem

However, attaching an electronic device to the outer surface of a vulcanized tire, for example, using adhesives, etc., is a laborious process, especially for a large tire.

Therefore, an object of the present disclosure is to provide a method for producing a tire and a tire, that can attach an electronic device to the vicinity of the tire outer surface of the tire side portion in a simple manner.

### Solution to Problem

The above problem can be solved by the following means.

(1) The method for producing a tire according to the present disclosure is,
a method for producing a tire to obtain a tire with an electronic device attached to a tire side portion, wherein
a lower mold piece and an upper mold piece are used as a mold for vulcanizing a raw tire, and including:
an electronic device arrangement process in which the electronic device is arranged in at least one of: the lower mold piece, the upper mold piece, the vicinity of a tire outer surface of the tire side portion of the raw tire on the side that comes into contact with the lower mold piece, and the vicinity of a tire outer surface of the tire side portion of the raw tire on the side that comes into contact with the upper mold piece; and
a vulcanization process in which the raw tire is set in the mold and vulcanized after the electronic device arrangement process.

(8) The tire according to the present disclosure is,
a tire produced by the method for producing a tire as described above.

According to the tire in accordance with the present disclosure, the electronic device can be attached to the vicinity of the tire outer surface of the tire side portion in a simple manner during the production of the tire.

### Advantageous Effect

According to the present disclosure, it is possible to provide a method for producing a tire and a tire, that can attach an electronic device to the vicinity of the tire outer surface of the tire side portion in a simple manner.

### BRIEF DESCRIPTION OF THE DRAWINGS

In the accompanying drawings:

FIG. 1 is a schematic cross-sectional view in the tire width direction of a tire in accordance with one embodiment of the present disclosure;

FIGS. 2A to 2C are drawings illustrating examples of an electronic device or an electronic device laminate that includes the electronic device, which can be used in a tire and a method for producing a tire in accordance with one embodiment of the present disclosure. FIG. 2A is a plan view schematically illustrating the electronic device, FIG. 2B is a perspective view schematically illustrating an example of the electronic device laminate, and FIG. 2C is a cross-sectional view in the longitudinal direction of the electronic device schematically illustrating another example of the electronic device laminate;

FIG. 3 is a schematic cross-sectional view in the tire width direction illustrating an example of a mold and a raw tire that can be used in the method for producing a tire in accordance with one embodiment of the present disclosure, to explain the method for the same;

FIG. 4 is an enlarged front cross-sectional view illustrating the area around a serial plate held in the upper mold piece in FIG. 3, together with the electronic device before being affixed to the serial plate;

FIG. 5 is a schematic view seen from the arrows X-X in FIG. 4;

FIGS. 6A to 6D are drawings that respectively illustrates different example of the configuration of the serial plate as a separate component from the mold, an elastic member, and the electronic device that are arranged in the electronic device arrangement process in the method for producing a tire in accordance with one embodiment of the present disclosure;

FIG. 7 is a drawing that illustrates an example of the arrangement relationship, on the circumference of the mold, of the electronic devices arranged on the lower mold piece side and the upper mold piece side, in the electronic device arrangement process in the method for producing a tire in accordance with one embodiment of the present disclosure; and

FIGS. 8A to 8D are drawings that respectively illustrates different example of the arrangement relationship, on the circumference of the mold, of the serial plate and electronic device arranged on the lower mold piece side and the upper mold piece side, in the electronic device arrangement process in the method for producing a tire in accordance with one embodiment of the present disclosure.

### DETAILED DESCRIPTION

The method for producing a tire in accordance with this disclosure and a tire in accordance with the same can be used as a method for producing a tire of any type and as a tire of the same. For example, they can be suitably used for passenger vehicle tires, truck/bus tires, construction/mining vehicle tires, etc., or as a method for producing such tires. In particular, they can be suitably used for the construction/mining vehicle tires, or as a method for producing such tires.

Hereinafter, embodiments of a method for producing a tire according to the present disclosure and a tire according to the same will be described by way of example with reference to the drawings.

The same components and parts are designated by the same reference numerals/symbols in each drawing.

As used herein, the term “tire circumferential direction” refers to the direction in which the tire rotates around its rotation axis, the term “tire radial direction” refers to the direction that is perpendicular to the rotation axis of the tire, and the term “tire width direction” refers to the direction that is parallel to the rotation axis of the tire. In some drawings, the tire circumferential direction is indicated by the symbol “CD”, the tire radial direction is indicated by the symbol “RD”, and the tire width direction is indicated by the symbol “WD”.

In addition, as used herein, the side that is closer to the rotation axis of the tire along the tire radial direction is referred to as the “inner side in the tire radial direction”, and the side that is farther from the rotation axis of the tire along the tire radial direction is referred to as the “outer side in the tire radial direction”. Also, as used herein, the side that is closer to the tire equatorial plane CL along the tire width direction is referred to as the “inner side in the tire width direction”, and the side that is further from the tire equatorial plane CL along the tire width direction is referred to as the “outer side in the tire width direction”. In addition, as used herein, the term “tire inner surface” refers to the surface of the tire that faces the inner cavity of the tire, and the term “tire outer surface” refers to the surface of the tire that faces the outside of the tire.

As used herein, the term “tire circumferential direction” and other terms, as well as symbols such as “CD”, shall be used not only for vulcanized tires (i.e., finished tires), but also for raw tires before vulcanization. In addition, in this document, the term “mold circumferential direction” and other terms, as well as symbols such as “CD”, may be used to refer to the mold, which is used to vulcanize raw tires, in the same way as above.

### Tire

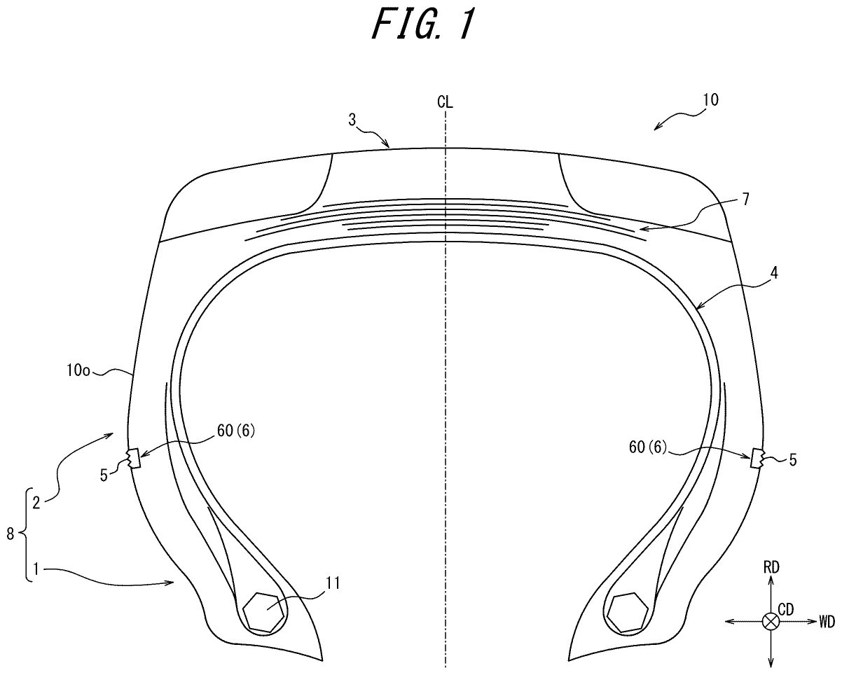

First, with reference to FIG. 1, what will be explained is an example of a tire that can be obtained by a method for producing a tire according to any embodiment of the present disclosure, and therefore, an example of a tire obtained by the above-mentioned method for producing a tire, in other words, a tire according to one embodiment of the present disclosure.

FIG. 1 is a drawing to explain a tire 10 according to one embodiment of the present disclosure, and is a schematic cross-sectional view in the tire width direction of the tire 10.

Since the tire 10 according to one embodiment of the present disclosure is a tire produced by the method for producing the tire according to any embodiment of the present disclosure as described below, it can enjoy the benefits of the method for producing the tire, which is described below. In other words, according to the tire 10, an electronic device can be attached to the vicinity of the tire outer surface of the tire side portion in a simple manner during the production of the tire 10.

It will be noted that the tire 10 according to embodiments of the present disclosure may be configured as a tire of any type and/or any size. For example, the tire 10 of this embodiment, and therefore, the tire 10 produced by the method for producing a tire according to one embodiment of the present disclosure described below, may be configured as a tire with a nominal rim diameter of 20 inches or more for the applicable rim. Examples of the nominal rim diameter in which the nominal rim diameter is 20 inches or more include 25 inches, 29 inches, 33 inches, 35 inches, 49 inches, 51 inches, 57 inches, and 63 inches. Even when the nominal rim diameter of the applicable rim for the tire 10 is 20 inches or more, according to this embodiment, the electronic device can be easily attached to the vicinity of the tire outer surface of the tire side portion of such a large tire, which is likely to cause communication issues, etc., if the electronic device is attached to the tire inner surface side.

As used herein, the term “nominal rim diameter of applicable rim” (hereinafter, simply referred to as “nominal rim diameter”) refers to the inner diameter of the tire, and thus the rim diameter of the applicable rim. More specifically, the term refers to the designation (in inches) of the rim diameter of the applicable rim, which is generally indicated in the tire size displayed on the sidewall portion of the tire, in other words, to the rim diameter of the applicable rim expressed in inches. For example, if the tire size is “29.5R25”, the nominal rim diameter is “25 inches”, if the tire size is “18.00R33”, the nominal rim diameter is “33 inches”, if the tire size is “46/90R57”, the nominal rim diameter is “57 inches”, and if the tire size is “59/80R63”, the nominal rim diameter is “63 inches”.

As used herein, the term “applicable rim” refers to the standard rim in the applicable size (Measuring Rim in ETRTO's STANDARDS MANUAL and Design Rim in TRA's YEAR BOOK) as described or as may be described in the future in the industrial standard, which is valid for the area in which the tire is produced and used, such as JATMA YEAR BOOK of JATMA (Japan Automobile Tyre Manufacturers Association) in Japan, STANDARDS MANUAL of ETRTO (The European Tyre and Rim Technical Organization) in Europe, and YEAR BOOK of TRA (The Tire and Rim Association, Inc.) in the United States. For sizes not listed in these industrial standards, the term “applicable rim” refers to a rim with a width corresponding to the bead width of the pneumatic tire. The “applicable rim” includes current sizes as well as future sizes to be listed in the aforementioned industrial standards. An example of the “sizes as described in the future” could be the sizes listed as “FUTURE DEVELOPMENTS” in the ETRTO 2013 edition.

The tire 10 in this embodiment is a pneumatic tire and has a bead portion 1, a sidewall portion 2, and a tread portion 3, as illustrated in FIG. 1.

The bead portion 1 is a portion that is configured to come into contact with a rim on its inner side in the tire radial direction and on its outer side in the tire width direction when the tire 10 is mounted on the rim. The tread portion 3 is a portion of the tire 10 that extends in the tire width direction between a pair of tread edges. The sidewall portion 2 is a portion that extends between the pair of bead portions 1 and the tread portion 3. In this document, the sidewall portion 2 and the bead portion 1 of the tire 10 are sometimes collectively referred to as a tire side portion 8. The above-mentioned sidewall portion 2 refers to a portion that extends inward in the tire radial direction than at least a belt 7 mentioned below, and outward in the tire radial direction from the bead portion 1.

More specifically, the tire 10 of this embodiment comprises: a pair of bead portions 1 having a bead core 11, a carcass 4 consisting of at least one (in the illustrated example, one) carcass ply 41 that extends in a toroidal shape between the pair of bead portions 1 via the pair of sidewall portions and the tread portion, a belt 7 consisting of at least one (in the illustrated example, six) belt layers that are provided on the outer side in the tire radial direction of the carcass 4 (i.e., the crown portion of the carcass 4) in the tread portion 3, and an electronic device 6 attached to the tire side portion 8 (or, to be more specific, the sidewall portion 2 in this example). As illustrated in FIG. 1, in this example, the tire outer surface 10o side of the electronic device 6 is engraved with a serial 5.

Here, as used herein, the term “electronic device” refers to a device that comprises an electronic component and has a communication function with the outside world, for example.

It will be noted that, in this document, the part of the tire 10 that does not include the electronic device 6 or the electronic device laminate 60 described below may be referred to as a “tire body”, and the part of the raw tire 20 described below that does not include the electronic device 6 or the electronic device laminate 60 described below may be referred to as a “raw tire body”.

In this example, each bead core 11 is embedded in the corresponding bead portion 1. The bead core 11 may include a plurality of bead wires that are surrounded by a rubber coating. However, the bead core 11 may consist of a single bead wire. The bead wire is preferably made of metal (e.g. steel). For example, the bead wire may be, for example, formed of a monofilament or a stranded wire. In addition, the bead wire may be made of organic fibers or carbon fibers, etc. In this example, as illustrated in FIG. 1, the cross-sectional shape in the tire width direction of the bead core 11 is a regular hexagon, however, the cross-sectional shape of the bead core 11 may be other shapes, such as polygonal shapes other than regular hexagons, circular shapes, etc.

In the present example, as illustrated in FIG. 1, the carcass 4 comprises a carcass body portion located between the bead cores 1 of the pair of bead portions 1, and carcass turn-up portions folded from the inner side to the outer side in the tire width direction around each bead core 11 from both ends of the carcass body portion. However, the carcass 4 does not have to comprise the carcass turn-up portions.

Each carcass ply constituting the carcass 4 includes one or more carcass cords and a coating rubber that covers the carcass cords. The carcass cord may be formed of a monofilament or a stranded wire, for example. In this example, the carcass cord is made of steel. Because the carcass cord is made of steel, sufficient strength can be obtained even in large tires with a simple radial structure.

In addition, in this example, the carcass 4 has a radial structure. In other words, each carcass cord included in the carcass 4 extends substantially along the tire width direction (i.e., in a projection view from the outer side in the tire radial direction of the tread portion 3, at an angle of substantially 0°, without inclining, with respect to the tire width direction).

However, the carcass cord may be made from organic fibers such as polyester, nylon, rayon, and aramid. In addition, the carcass 4 may have a bias structure.

In this example, each belt layer constituting the belt 7 includes one or more belt cords and a coating rubber that covers the belt cords. The belt cord may be formed of a monofilament or a stranded wire, for example. The belt cord may be made of metal (e.g. steel) or organic fibers such as polyester, nylon, rayon, or aramid.

The serial 5 is an identification mark that uses letters, numbers, symbols, and graphics, etc., to indicate the serial number, production date, name of manufacturer of the tire, etc., and is intended to make it easier to identify the type, etc., of tire that has been produced. The serial 5, for example, is stamped on the tire 10 using a serial plate 50 described below.

As illustrated in FIG. 1, in this example, more specifically, the electronic device 6 is arranged in the vicinity of the tire outer surface 10o in the tire side portion 8. Here, in this document, the terms “in the vicinity of the tire outer surface” or “near the tire outer surface” refer to a position on the outer side in the tire width direction than at least the carcass 4 (more specifically, in this case, the carcass turn-up portion of the carcass 4), and this includes the position on the tire outer surface.

The electronic device 6 may be embedded in the tire side portion 8 or attached on the tire outer surface 10o of the tire side portion 8. In the example in FIG. 1, the electronic device 6 is embedded in the sidewall portion 2.

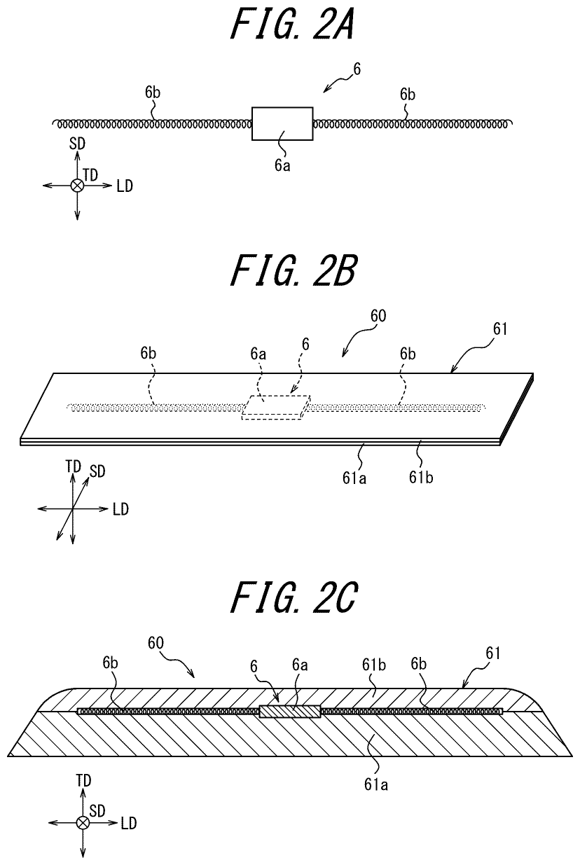

In addition, in this embodiment, the electronic device 6 may be attached to the tire side portion 8 of the tire 10 as a single electronic device (see FIG. 2A), or may be attached to the tire side portion 8 of the tire 10 as the electronic device laminate 60 (see FIGS. 2B to 2C) that includes the electronic device 6, which is provide with an elastic member 61 on at least part of the surface of the electronic device 6. In other words, the electronic device 6 may be used as a single electronic device (see FIG. 2A) or as the electronic device laminate 60 (see FIGS. 2B to 2C) in the electronic device arrangement process in the method for producing a tire according to one embodiment of the present disclosure, which will be described later. In the electronic device arrangement process, if the electronic device 6 is provided with the elastic member 61 on at least part of the surface of the electronic device 6, the durability of the electronic device 6 and/or the adhesiveness of the same to the tire body can be improved.

In this embodiment, it is suitable that the electronic device 6 is arranged at a position where the depth from the tire outer surface 10o of the tire side portion 8 is 0.1 to 10.0 mm. In this case, the electronic device 6 is less likely to be damaged while the tire is in motion, which in turn improves the durability of the electronic device 6, and it is also easier to read the information on the electronic device 6 from the outside. From the same perspective, it is even more suitable if the electronic device 6 is arranged at a position where the depth from the tire outer surface 10o of the tire side portion 8 is 0.5 to 5.0 mm.

It will be noted that if the electronic device 6 is an RF tag as illustrated in any of FIGS. 2A to 2C described later, for example, the thin-plate like IC chip 6a may be attached to the tire outer surface 10o so that the surfaces on both sides in the thickness direction TD of the IC chip 6a (for example, in FIG. 2A, the surfaces on the front and back sides of the paper) are aligned with the tire outer surface 10o (i.e. so that they are both approximately parallel), and the center in the thickness direction TD of the IC chip 6a may be arranged at the above-mentioned depth position.

In the illustrated example, the tread rubber that forms the tread surface, which is the tire outer surface 10o in the tread portion 3, is provided on the outer side in the tire radial direction of the belt 7 in the tread portion 3. The tread pattern is formed on the tread surface. In this example, the tread pattern is a lug pattern in which lugs are formed in the tire circumferential direction by lug grooves, but the tread pattern is not limited to this.

Also, in the illustrated example, the side rubber that forms the tire outer surface 10o of the tire side portion 8 is provided on the outer side in the tire width direction of the carcass 4 in the tire side portion 8.

The inner surface of the tire 10 in this embodiment is configured with an inner liner (not illustrated in particular) with low permeability to air and/or gas.

FIGS. 2A to 2C are drawings illustrating examples of the electronic device or the electronic device laminate that includes the electronic device, which can be used in a tire and a method for producing a tire in accordance with one embodiment of the present disclosure. FIG. 2A is a plan view schematically illustrating the electronic device, FIG. 2B is a perspective view schematically illustrating an example of the electronic device laminate, and FIG. 2C is a cross-sectional view in the longitudinal direction of the electronic device schematically illustrating another example of the electronic device laminate.

As illustrated in FIG. 2A, in this example, the electronic device 6 is an RF tag that has an IC chip 6a with a storage section, etc., and one or more (in the illustrated example, two) antennas 6b that transmit and/or receive electromagnetic waves. An RF tag is also generally called as an RFID (Radio Frequency Identification) tag.

In this example, the antennas 6b are connected to the IC chip 6a and extends in a straight line, a wave-like shape, or a spiral shape (in the illustrated example, a spiral shape). In this example, two antennas 6b extend from the IC chip 6a in opposite directions. However, the antennas 6b may extend from the IC chip 6a in only one direction. In addition, in this example, the two antennas 6b have the same length along the long side direction LD of the IC chip 6a, which will be described later. However, the two antennas may have different lengths along the long side direction LD of the IC chip 6a.

In this example, the IC chip 6a has a thin plate shape with a generally rectangular shape in a plan view (see FIG. 2A). Here, the “thickness” of the IC chip 6a refers to the thickness in the direction (hereafter, also referred to as the “thickness direction of the IC chip (6a)”) perpendicular to both of: the direction, in a plan view, parallel to the long side of the IC chip 6a (hereafter, also referred to as the “long side direction of the IC chip (6a)”) LD; and the direction, in a plan view, parallel to the short side of the IC chip 6a (hereafter, also referred to as the “short side direction of IC chip (6a)”) SD. It will be noted that, in this example, the long side direction LD of the IC chip (6a) is also the long side direction of the electronic device (6), the short side direction SD of the IC chip (6a) is also the short side direction of the electronic device (6), and the thickness direction TD of the IC chip (6a) is also the thickness direction of the electronic device (6).

The IC chip 6a has, for example, a storage section that is any known memory and a controller that is any known processor. The IC chip 6a may operate by the induced electromotive force generated by the electromagnetic waves received by the one or more antennas 6b. In other words, the electronic device 6 may be a passive communication device. Alternatively, the electronic device 6 may be further provided with a battery and be able to generate electromagnetic waves and communicate using its own power. In other words, the electronic device 6 may be an active communication device. The controller of the IC chip 6a can, for example, read data such as production management, shipping management, and usage history management of the tire stored in the storage section, or write these data to the storage section.

FIG. 2B illustrates an example of the electronic device laminate 60 that includes the electronic device 6, which comprises the elastic member 61 on at least part of the surface of the electronic device 6. In other words, in this example, the electronic device 6 comprises the elastic member 61 on at least part of the surface of the electronic device 6. More specifically, in this example, the electronic device 6 is configured as an electronic device laminate 60 which is provided with a one-side elastic member 61a on the entire surface of one side in the thickness direction TD of the electronic device 6, and an other-side elastic member 61b on the entire surface of the other side in the thickness direction TD of the electronic device 6. As illustrated in FIG. 2B, in this example, the elastic members 61 (one-side elastic member 61a and the other-side elastic member 61b) are, for example, thin sheet-shaped rubber. In other words, in this example, the electronic device 6 is configured as an electronic device laminate 60, in which the entire surface of one side and the other side in the thickness direction TD thereof is coated with a sheet-like coating rubber.

It will be noted that the configuration of the electronic device 6 itself in the example of FIG. 2B is the same as the configuration of the electronic device 6 in FIG. 2A described above as a single electronic device 6.

FIG. 2C illustrates another example of the electronic device laminate 60, that includes the electronic device 6 in which the elastic member 61 is provided on at least part of the surface of the electronic device 6. In other words, in this example, as in the example in FIG. 2B, the electronic device 6 has the elastic member 61 on at least part of the surface of the electronic device 6. More specifically, in this example, as in the example in FIG. 2B, the electronic device 6 is configured as an electronic device laminate 60 which is provided with a one-side elastic member 61a on the entire surface of one side in the thickness direction TD of the electronic device 6, and an other-side elastic member 61b on the entire surface of the other side in the thickness direction TD of the electronic device 6. In this example, as in the example in FIG. 2B, the elastic members 61 (one-side elastic member 61a and the other-side elastic member 61b) can be made of rubber, for example. However, as illustrated in FIG. 2C, in this example, unlike the example in FIG. 2B, the elastic members 61 (one-side elastic member 61a and the other-side elastic member 61b) are not thin sheets, but rather slightly thicker patches. In this example, the thickness of the one-side elastic member 61a is thicker than the thickness of the other-side elastic member 61b, however, the relationship between the thicknesses of the two is not particularly limited. In other words, in this example, the electronic device 6 is configured as an electronic device laminate 60, in which the entire surface on one side and the entire surface on the other side in the thickness direction TD are covered with patch-shaped coating rubber.

It will be noted that, the configuration of the electronic device 6 itself in the example of FIG. 2C is the same as the configuration of the electronic device 6 in FIG. 2A described above as a single electronic device 6.

In the examples illustrated in FIGS. 2B and 2C above, the electronic device 6 has the elastic member 61 covering the entire surface of the electronic device 6. However, when the electronic device 6 is configured as an electronic device laminate 60, the electronic device 6 may comprise the elastic member 61 only on at least part of the surface of the electronic device 6. For example, in the examples of FIGS. 2B and 2C, the electronic device 6 may comprise the elastic member 61 only on part or all of the one-side surface or part or all of the other-side surface in the thickness direction TD of the electronic device 6.

As mentioned above, the electronic device 6 as a single electronic device or the electronic device laminate 60 that includes the electronic device 6 can be used in the electronic device arrangement process in the method for producing a tire according to one embodiment of the present disclosure described below, and therefore, the electronic device 6 as a single electronic device or the electronic device laminate 60 that includes the electronic device 6 may be being attached to the tire side portion 8 of the tire, which is produced by the method for producing a tire, i.e., the tire 10 according to one embodiment of the present disclosure as explained with reference to FIG. 1.

It will be noted that, in FIG. 1, the electronic device laminate 60 that includes the electronic device 6 is illustrated in a simplified form. However, in the example illustrated in FIG. 1, the electronic device 6 is attached to the vicinity of the outer surface of the tire 10o so that the surfaces on one side and the other side of the thin plate-shaped IC chip 6a are aligned with the outer surface of the tire 10o (i.e., so that the two are approximately parallel).

In the tire 10 illustrated in FIG. 1, which is one embodiment of the present disclosure, if the electronic device 6 is an RF tag such as the one illustrated in FIG. 2A and has the antenna 6b, the electronic device 6 may be attached to the tire 10 so that the antenna 6b extends in the direction that intersects the extending direction of the carcass cord included in the carcass ply of the carcass 4 (preferably, in a direction perpendicular to the extending direction). If the carcass 4 has a radial structure, in this case, the entire length in the longitudinal direction LD of the electronic device 6 is prevented from being bent significantly by the bending strain of the sidewall portion 2, and the durability of the electronic device 6 can be improved.

### <Method for Producing a Tire >

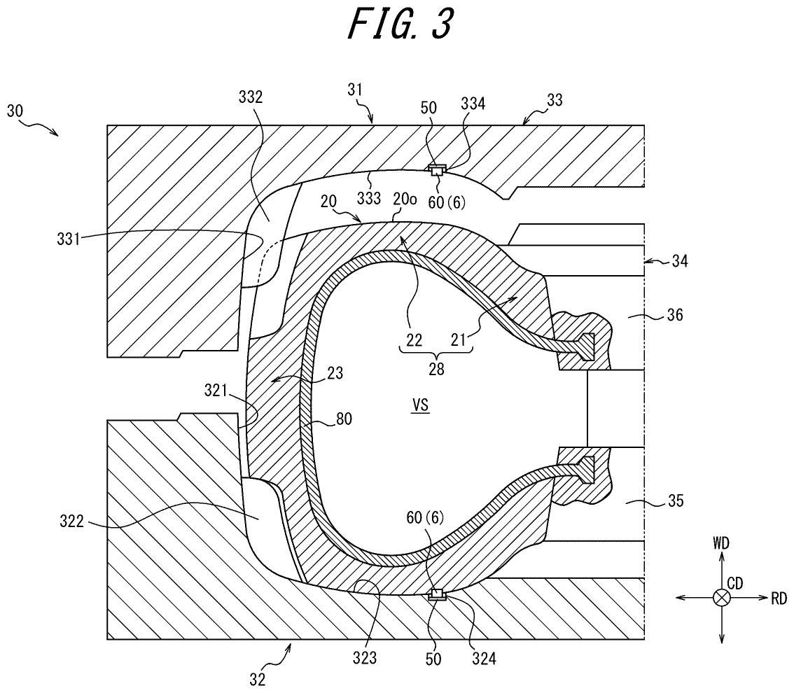

Next, a method for producing a tire according to one embodiment of the present disclosure will be described with reference to FIGS. 3 to 5.

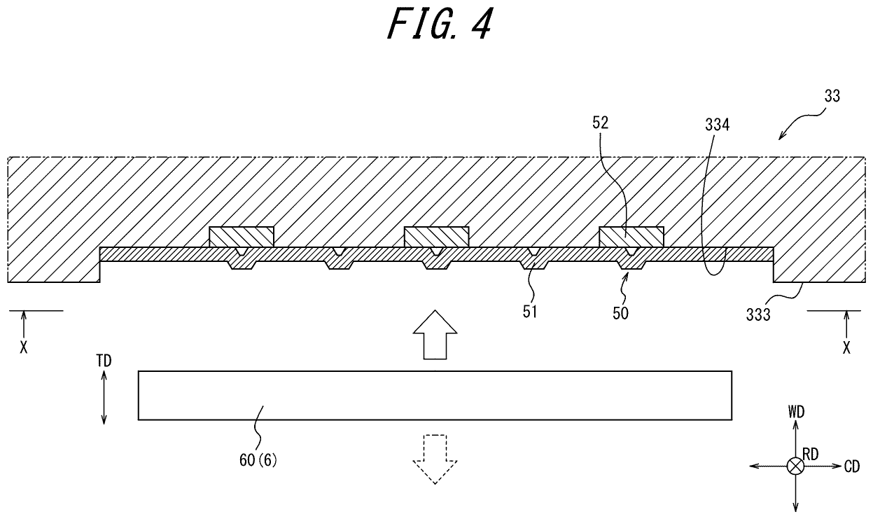

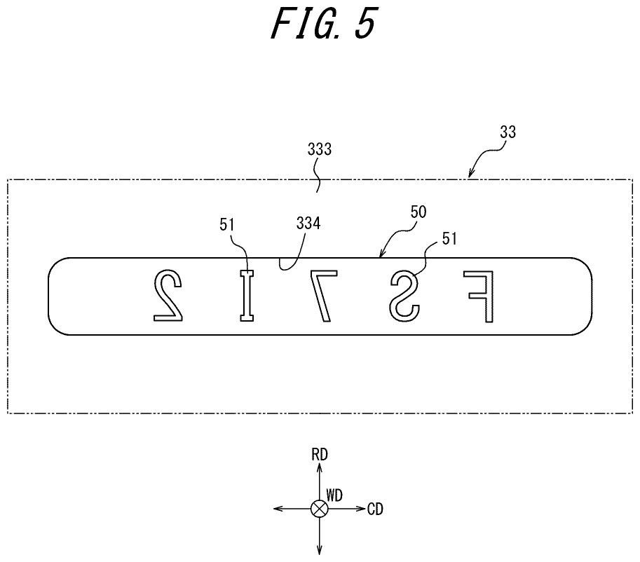

FIG. 3 is a schematic cross-sectional view in the tire width direction illustrating an example of a mold and a raw tire that can be used in the method for producing a tire in accordance with one embodiment of the present disclosure, to explain the method for producing a tire in accordance with the same. FIG. 4 is an enlarged front cross-sectional view illustrating the area around a serial plate held in the upper mold piece in FIG. 3, together with the electronic device which is to be affixed to the serial plate. FIG. 5 is a schematic view seen from the arrows X-X of FIG. 4.

First, a mold that can be used in the method for producing a tire according to one embodiment of the present disclosure will be described.

In FIG. 3, the reference numeral 30 is a tire vulcanizing apparatus, and this tire vulcanizing apparatus 30 can produce a tire 10, such as the one illustrated in FIG. 1, by vulcanizing an unvulcanized tire, that is, a raw tire 20. The raw tire 20, same as the tire 10, comprises a pair of bead portions 21, sidewall portions 22 that extend to the outer side in the tire radial direction from each bead portion 21, and a tread portion 15 that connects the outer edges in the tire radial direction of these sidewall portions 22. In this document, the sidewall portion 22 and the bead portion 21 of the raw tire 20 are sometimes collectively referred to as the tire side portion 28. Here, in FIG. 3, the internal components of the tire, such as bead cores, a carcass, and a belt, which are the same as those of the tire 10, are omitted for the sake of simplicity.

In this example, the tire vulcanizing apparatus 30 has a mold 31, which is configured with at least an approximately ring-shaped lower mold piece 32 and an approximately ring-shaped upper mold piece 33. The lower mold piece 32 has a tire side portion molding surface 323 on its upper surface of the area that is approximately in the center in the tire radial direction, that molds at least part of the tire side portion 28 on one side (lower side) of the raw tire 20. Similarly, the upper mold piece 33 has a tire side portion molding surface 333 on its lower surface of the area that is approximately in the center in the tire radial direction, that molds at least part of the tire side portion 28 on the other side (upper side) of the raw tire 20.

In FIG. 3, the reference numerals 321 and 331 indicate tread portion molding surfaces of the mold 31 that performs molding on the tread portion 23 of the raw tire 20, and the reference numerals 322 and 332 indicate, respectively, the lug groove forming frameworks in the mold 31 for forming the lug grooves in the tire half on one side (the lower side) and the tire half on the other side (the upper side) of the raw tire 20. As illustrated in FIG. 3, the lug groove forming frameworks 322 and 333 respectively protrude inward in the tire radial direction from the outer end portion in the tire radial direction of the lower mold piece and the outer end portion in the tire radial direction of the upper mold piece, and are arranged at equal distances, for example, in the tire circumferential direction.

In this example, the tire vulcanizing apparatus 30 has a shaping unit 34. The shaping unit 34 has an one-side support 35 on which the bead portion 21 on one side (the lower side) of the raw tire 20 may seat to mainly mold the bead portion 21, and the other-side support 36 on which the bead portion 21 on the other side (the upper side) of the raw tire 20 may seat to mainly mold the bead portion 21. These one-side support 35 and the other-side support 36 can be may be detachably connected by a connecting mechanism not illustrated in the figure.

In FIG. 3, the reference numeral 80 represents a flexible bladder provided in the shaping unit 34 in which one end and the other end in the tire width direction thereof are secured in a sealed state on the one-side support 35 and the other-side support 36, respectively.

In the examples in FIGS. 3 to 5, the reference numerals 324 and 334 are, respectively, recesses with a roughly rectangular shape in a plan view (see FIG. 5) for holding the serial plate 50, formed in the tire side portion forming surface 323 and 333. In this example, the bottom walls of the recesses 324 and 325 are, in the cross-sectional views in FIGS. 3 and 4, composed of flat surfaces that are almost parallel to the tangent lines of the tire side portion molding surfaces 323 and 333 at the positions of the recesses 324 and 334, respectively.

The recesses 324 and 334 each hold the serial plate 50 made of, for example, a thin steel plate. In this example, each of these serial plates 50 presents a roughly rectangular shape that is virtually identical to the recesses 324 and 334 in a plan view (see FIG. 5). These serial plates 50 may be made of metal plates such as stainless steel, aluminum, and aluminum alloy. On each of these serial plates 50, an identification mark 51 consisting of letters, numbers, symbols, and/or shapes, etc., is stamped using a press or other device to indicate the serial number, production date, manufacturer's name, etc. When these identification marks 51 are stamped on the raw tire 20 and then on the produced tire 10 by transfer, it becomes easy to identify the type, etc., of the produced tire 10. In this example, as illustrated in FIGS. 4 and 5, each identification mark 51 is arranged at approximately equal distances in the longitudinal direction of the serial plate 50 and therefore in the tire circumferential direction, and protrudes from the back surface of the serial plate 50 toward the front surface of the same.

If the serial plate 50 is made of a ferromagnetic material such as steel, it is preferable to embed one or more (in this case, a plurality of) magnets (e.g., permanent magnets) 52 in the bottom wall or near the bottom wall of the recess 334 of the upper mold piece 33, as illustrated in FIG. 4, and to attract the serial plate 50 with the magnets 52. This makes it possible to effectively prevent the serial plate 50 from falling off the upper mold piece 33, for example, by raising and lowering the upper mold piece 33 before and after vulcanization, etc., with a simple structure.

It will be noted that, in the electronic device arrangement process in the method for producing a tire according to one embodiment of the present disclosure described below, the serial plate 50 is used, for example, by being affixed to the electronic device 6 or the electronic device laminate 60 that includes the electronic device 6. However, in FIG. 4, the electronic device 6 or the electronic device laminate 60 before being affixed to the serial plate 50 is illustrated together with the solid white arrow showing the relative position of the affixed surfaces of each other. The dotted white arrow in FIG. 4 indicates that the electronic device 6 or the electronic device laminate 60 may be arranged in the raw tire 20 (not illustrated in FIG. 4).

In FIGS. 4 and 5, only the recess 334 on the upper mold piece 33 and the cereal plate 50 held in the recess 334 are illustrated, but the recess 324 on the lower mold piece 32 and the cereal plate 50 held in the recess 324 may have a similar structure. In addition, the arrows in FIGS. 4 and 5, which indicate the tire radial direction RD and the tire width direction WD, do not necessarily indicate the exact tire radial direction RD and tire width direction WD.

Here, in this example, as illustrated in FIG. 3, the electronic device 6 (including the electronic device 6 included in the electronic device laminate 60. The same applies below.) is arranged in the lower mold piece 32 and the upper mold piece 33. To be more specific, in this example, the electronic device 6 is attached to the serial plate 50, which is a separate component from the mold 31, and is arranged in the lower mold piece 32 and the upper mold piece 33 via the serial plate 50, which is a separate component from the mold 31.

However, it is sufficient that the electronic device 6 is arranged in at least one of: the lower mold piece 32; the upper mold piece 33; the vicinity of the tire outer surface 20o of the tire side portion 28 of the raw tire 20 on the side that comes into contact with the lower mold piece 32; and the vicinity of the tire outer surface 20o of the tire side portion 28 of the raw tire 20 on the side that comes into contact with the upper mold piece 33, in a state that the raw tire 20 is placed in the vulcanization space VS, the lower mold piece 32 and the upper mold piece 33 are closed together, and vulcanization has not begun yet.

Hereinafter, a method for producing a tire according to one embodiment of the present disclosure will be described. The method for producing a tire in this embodiment is to produce the tire 10 using the tire vulcanizing apparatus 30, and in therefore, using the mold 31, the lower mold piece 32, and the upper mold piece 33, as explained using FIGS. 3 to 5.

The method for producing a tire according to this embodiment is a method for producing a tire to obtain a tire 10 in which the electronic device 6 is attached to the tire side portion 8, as described above, for example, while referring to FIG. 1. As mentioned above, the type and/or size of the tire may be arbitrary, however, the tire 10 may be configured as a tire with a nominal rim diameter of the applicable rim of 20 inches or more.

The method for producing a tire in this embodiment uses the lower mold piece 32 and the upper mold piece 33 as the mold 31 for vulcanizing the raw tire 20. The configuration of the mold 31, the lower mold piece 32, and the upper mold piece 33 is not particularly restricted, as long as the lower mold piece 32 is provided on the lower side in the vertical direction and the upper mold piece 33 is provided on the upper side in the vertical direction than the lower mold piece 32. As the mold 31, the lower mold piece 32, and the upper mold piece 33, for example, the mold 31, the lower mold piece 32, and the upper mold piece 33 as previously described with reference to FIGS. 3 to 5 can be used.

The method for producing a tire according to this embodiment includes an electronic device arrangement process and a vulcanization process.

### Electronic Device Arrangement Process

Referring to FIG. 3, in the electronic device arrangement process, the electronic device 6 is arranged in at least one of: the lower mold piece 32, the upper mold piece 33, the vicinity of the tire outer surface 20o of the tire side portion 28 of the raw tire 20 on the side that comes into contact with the lower mold piece 32, and the vicinity of the tire outer surface 20o of the tire side portion 28 of the raw tire 20 on the side that comes into contact with the upper mold piece 33. Here, the “tire side portion 28 of the raw tire 20 on the side that comes into contact with the lower mold piece 32 (or the upper mold piece 33)” refers to the tire side portion 28 of the tire half of the raw tire 20 on the side that comes into contact with the lower mold piece 32 (or the upper mold piece 33) during the vulcanization process described below.

To be more specific, in the example using the tire vulcanizing apparatus 30 illustrated in FIG. 3, in the electronic device arrangement process, the electronic device 6 is arranged in the lower mold piece 32 and the upper mold piece 33 (specifically, the tire side portion molding surface 323 of the lower mold piece 32 and the tire side portion molding surface 333 of the upper mold piece 33). However, as mentioned above, in the electronic device arrangement process, the electronic device 6 may be arranged in at least one of: the lower mold piece 32; the upper mold piece 33; the vicinity of the tire outer surface 20o of the tire side portion 28 of the raw tire 20 on the side that comes into contact with the lower mold piece 32; and the vicinity of the tire outer surface 20o of the tire side portion 28 of the raw tire 20 on the side that comes into contact with the upper mold piece 33. In other words, the electronic device 6 may be arranged in one or more locations selected from these.

The electronic device 6 may be arranged in the above-mentioned locations as a single electronic device 6 as described above, referring to FIG. 2A, or as an electronic device 6 included in the electronic device laminate 60 as described above, referring to FIGS. 2B to 2C, so that the electronic device 6 may be arranged in the above-mentioned locations by arranging the electronic device laminate 60 in the above-mentioned locations.

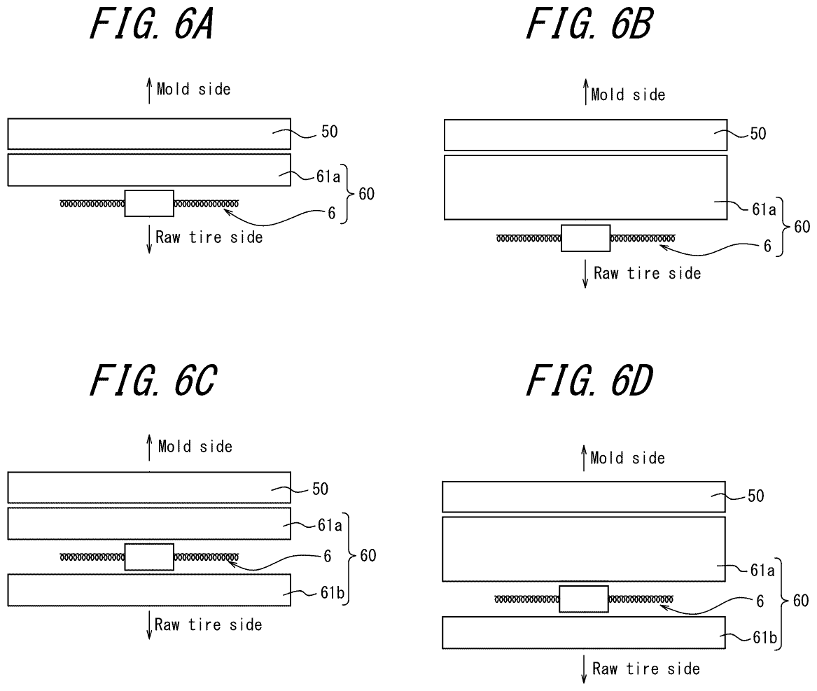

To be more specific, in the example using the tire vulcanizing apparatus 30 illustrated in FIG. 3, in the electronic device arrangement process, the electronic device 6 is not directly arranged in the mold 31 (and therefore, the lower mold piece 32 and/or the upper mold piece 33), but is attached to a component separate from the mold 31 (and therefore, the lower mold piece 32 and/or the upper mold piece 33) (for example, to the serial plate 50 illustrated in FIG. 6 below), and is arranged in the lower mold piece 32 and/or the upper mold piece 33 via the component separate from the mold 31. The electronic device 6 is preferably attached to the side facing the raw tire 20 of the component separate from the mold 31. This allows, in the produced tire 10, the marks, etc. stamped on the tire using the component separate from the mold 31 to be used as a marker for the position where the electronic device 6 is located, and also makes it easy to arrange the electronic device 6 in the position of the mark, etc. It will be noted that if, for example, the electronic device 6 is arranged in the lower mold piece 32 and/or the upper mold piece 33 as the electronic device laminate 60 as illustrated in FIGS. 2B to 2C, the term “component separate from the mold 31” shall not include the elastic member 61 (one-side elastic member 61a and other-side elastic member 61b) contained in the electronic device laminate 60.

In this example using the tire vulcanizing apparatus 30 illustrated in FIG. 3, the component that is separate from the mold 31 is the serial plate 50. This allows, in the produced tire 10, the serial 5, which is normally stamped on the regular tire 10 using the regular serial plate 50, to be used as a marker to indicate the position of the electronic device 6, without the need for additional marks or the like, and also makes it easy to arrange the electronic device in the position of the serial 5. However, the component separate from the mold 31 is not limited to the serial plate 50, and may be, for example, an additional plate separate from the serial plate 50 for imprinting additional marks as a marker that allows the position of the electronic device 6 to be seen in the produced tire 10. However, from the perspective of being able to efficiently see the location of the electronic device 6 without additional marks, etc. made by the additional plate, the component separate from the mold 31 is preferably the serial plate 50.

### Vulcanization Process

Referring to FIG. 3, in the vulcanization process, the raw tire 20 is set in the mold 31 and vulcanized after the electronic device arrangement process described above.

To be more specific, in the example using the tire vulcanizing apparatus 30 illustrated in FIG. 3, in the vulcanization process, for example, after the bead portions 21 of the unvulcanized raw tire 20 are seated on the one-side support 35 and the other-side support 36, respectively, these one-side support 35 and other-side support are connected by a connection mechanism not illustrated in the drawing, and then internal pressure is filled in the bladder 80. As a result of this, the raw tire 20 is supported by the shaping unit 34, which is configured with the one-side support 35, the other-side support 36, and the bladder 80, while deforming into a roughly toroidal shape. Next, the raw tire 20, which has been mounted to the shaping unit 34 in this way, is placed in the upper mold piece 33 while in an open state using a transfer method not illustrated in the drawing, and then placed onto the lower mold piece 32 while aligning the lug groove forming frameworks 322 of the lower mold piece 32 with the lug groove forming grooves formed in the tire half on one side (lower side) of the raw tire 20. After that, the lower mold piece 32 and the upper mold piece 33 are closed, and the raw tire 20 is set (stored) inside the mold 31, i.e., inside the vulcanization space VS, and then high-temperature, high-pressure vulcanization medium is supplied to the bladder 80 to vulcanize the raw tire 20.

It will be noted that, in the vulcanization process, the identification mark 51 formed on the serial plate 50 is transferred and imprinted on the raw tire 20, and in the tire 10 after vulcanization, i.e., the produced tire 10, a serial 5 is formed, which comprises a recess and other features that are complementary to the identification mark 51. After vulcanization, the serial plate 50 is removed from the tire 10.

In addition, in this example, during the vulcanization process, the electronic device 6 attached to the side facing the raw tire 20 of the serial plate 50 is fixed to the raw tire 20, and in the tire 10 after vulcanization, i.e., the produced tire 10, the electronic device 6 is attached to the tire 10.

Next, the main effects of the above-mentioned embodiments are explained below.

First, according to the method for producing a tire of this embodiment, the lower mold piece 32 and the upper mold piece 33 are used as the mold 31 for vulcanizing the raw tire 20. This makes it possible to easily vulcanize the larger-sized raw tire 20 that corresponds to the tire 10 to be produced, even if the tire 10 to be produced is a large-sized tire, for example, with a nominal rim diameter of the applicable rim is 20 inches or more.

In addition, according to the method for producing a tire of this embodiment, in the electronic device arrangement process, the electronic device 6 is arranged in at least one of: the lower mold piece 32, the upper mold piece 33, the vicinity of the tire outer surface 20o of the tire side portion 28 of the raw tire 20 on the side that comes into contact with the lower mold piece 32, and the vicinity of the tire outer surface 20o of the tire side portion 28 of the raw tire 20 on the side that comes into contact with the upper mold piece 33, and the raw tire 20 is vulcanized in the vulcanization process. This allows the electronic device 6 to be attached to the vicinity of the tire outer surface 10o of the tire side portion 8 of the tire 10 in a simple way that only involves vulcanizing the raw tire 20, without the necessity of attaching the electronic device 6 to the outer surface 10o of the tire 10 after vulcanization. This is particularly useful when the tire is a large size, such as when the nominal rim diameter of the applicable rim is 20 inches or more.

As a result of the above, according to the method for producing a tire according to this embodiment, it is possible to attach the electronic device 6 to the vicinity of the tire outer surface 10o of the tire side portion 8 of the produced tire 10, and therefore, it is possible to improve the communication performance of the electronic device 6.

In this embodiment, the effects of the following that: in the electronic device arrangement process, the electronic device 6 is attached to a component separate from the mold 31 and arranged in the lower mold piece 32 and/or the upper mold piece 33 via the component separate from the mold 31; and the component separate from the 31 is the serial plate 50, are as described above.

The following is a further explanation of the suitable configurations and variant examples, etc., in the method for producing a tire according to the present embodiment.

As mentioned above, in the electronic device arrangement process, it is preferable that the electronic device 6 is provided with the elastic member 61 (the one-side elastic member 61a and/or the other-side elastic member 61b) on at least part of the surface of the electronic device 6, in other words, that the electronic device 6 is configured as an electronic device laminate 60 including the electronic device 6, as illustrated in FIGS. 2B to 2C. In this case, it is possible to insert the elastic member 61 between the electronic device 6 and the lower mold piece 32, upper mold piece 33, and/or the raw tire 20 during the vulcanization process, and this in turn improves the durability and/or adhesion of the electronic device 6 to the tire body.

Here, FIGS. 6A to 6D (hereinafter, collectively referred to as “FIG. 6”) are drawings illustrating different examples of the configuration of the serial plate which is a component separate from the mold, the elastic member, and the electronic device, to be arranged in the electronic device arrangement process in the method for producing a tire according to one embodiment of the present disclosure. FIGS. 6A to 6D are schematic drawings that are only intended to illustrate the relative positions in the tire width direction of the serial plates 50, etc., and the approximate relationship between the thicknesses of the one-side elastic member 61a and the other-side elastic member 61b. In reality, the serial plates 50, etc., are firmly attached to each other, and the dimensions, etc., are not exact. The electronic device 6, the electronic device laminate 60, the one-side elastic member 61a, and the other-side elastic member 61b in FIGS. 6A to 6D correspond to those in FIGS. 2B to 2C, respectively. In FIG. 6, the electronic device 6 is drawn with the vertical direction of the paper as the thickness direction TD (not illustrated) of the electronic device 6.

However, the configuration of: the serial plate 50 which is a component separate from the mold 31, the elastic member (one-side elastic member 61a and/or the other-side elastic member 61b), and the electronic device 6 which are arranged in the electronic device arrangement process is not limited to the example illustrated in FIG. 6.

As illustrated in FIG. 6, the electronic device 6 used in the electronic device arrangement process may have the elastic members (the one-side elastic member 61a and the other-side elastic member 61b) on both surfaces in the thickness direction (see FIGS. 2C and 2D), or it may have the elastic member (the one-side elastic member 61a) on the surface of only one side in the thickness direction, in particular, on the surface facing the serial plate 50 (see FIG. 2A and 2B). When the electronic device 6 comprises the elastic member (the one-side elastic member 61a) on the surface facing the serial plate 50, the durability of the electronic device 6 and the adhesion of the electronic device 6 to the serial plate 50 are improved. When the electronic device 6 also comprises the elastic member (the other-side elastic member 61b) on the surface facing the raw tire 20, the durability of the electronic device 6 will be further improved, and the adhesion of the electronic device 6 to the raw tire 20 and therefore the tire 10 to be produced will be improved.

In addition, the thickness of the elastic member (the one-side elastic member 61a) differs between the examples in FIGS. 6A and 6B, and FIGS. 6C and 6D. The thicker the elastic member, the more durable the electronic device 6 will be.

In the electronic device arrangement process, when the electronic device 6 to be arranged in the mold 31 (the lower mold piece 32 and/or the upper mold piece 33) (see FIG. 3) is arranged in the mold 31 in the configuration illustrated in FIG. 6, for example, it is preferable that the serial plate 50, the elastic members (the one-side elastic member 61a and/or the other-side elastic member 61b), and the electronic device 6 are integrated in advance before being arranged in the mold 31. In this case, it is possible to improve the work efficiency when arranging the electronic device 6 in the mold 31, and it is also possible to prevent the electronic device 6 from being misaligned with respect to the serial plate 50.

In addition, in the above case, when integrating the above components, the elastic members (the one-side elastic component 61a and/or the other-side elastic component 61b) may be heated to ensure the adhesion between the components using the elastic members.

In addition, in the electronic device arrangement process, for example, in each of the examples in FIG. 6, when the serial plate 50, the elastic members (the one-side elastic member 61a and/or the other-side elastic member 61b), the electronic device 6, and the mold 31 are firmly attached and integrated with each other, it is suitable for the interval between the center in the thickness direction of the electronic device 6 and the serial plate 50 to be 0.1 to 10.0 mm. In this case, the electronic device 6 is less likely to be damaged while the tire is in motion, and the durability of the electronic device 6 can be improved. In addition, it is easy to read the information of the electronic device 6 from the outside. From the same perspective, the above interval is even more suitable when it is 0.5 to 5.0 mm.

In the electronic device arrangement process, the electronic device 6 is preferably arranged in the lower mold piece 32 and/or the upper mold piece 33, and therefore on the mold 31, via an adhesive. In this case, for example, the electronic device 6 can be prevented from slipping or falling out of the mold 31 during the subsequent vulcanization process. To be more specific, in the electronic device arrangement process, the electronic device 6 may be directly attached to the mold 31 via an adhesive (not illustrated in the figure), but the electronic device 6 may also be arranged with respect to the mold 31 via the elastic member (the one-side elastic member 61a) and the member separate from the mold 31 (e.g., the serial plate 50), as in each example in FIG. 6. In this case, the electronic device 6 may be arranged in the mold 31 via the adhesive provided between at least one adjacent member of each member from the electronic device 6 to the mold 31. For example, in each of the examples illustrated in FIG. 6, the electronic device 6 can be placed in the mold 31 via the adhesive (not illustrated) provided only between the one-side elastic member 61a and the serial plate 50.

It will be noted that if the electronic device 6 is arranged in both the lower mold piece 32 and the upper mold piece 33, the adhesive may be used only on the upper mold piece 33, that is, the electronic device 6 may be arranged via the adhesive only on the upper mold piece 33. This is because the electronic device 6 is likely to fall from the upper mold piece 33.

In the electronic device arrangement process, the electronic device 6 is preferably arranged in both the lower mold piece 32 and the upper mold piece 33. In this case, the electronic device 6 is attached to both the vicinity of the tire outer surface 10o of the tire side portion 8 of the tire half on one side, and the vicinity of the tire outer surface 10o of the tire side portion 8 of the tire half on the other side with the tire equatorial plane CL as the boundary, so the information stored in the electronic device 6 can be read from the outside on both sides in the tire width direction. Therefore, regardless of the direction in which the tire 10 is attached to the vehicle, for example, even if a large tire is used, the communication capability of the electronic device 6 can be guaranteed, and even if, for example, one side of the electronic device 6 fails and stops functioning, it will still be possible to read information from the electronic device 6 on the other side.

However, in the electronic device arrangement process, the electronic device 6 may be arranged in only one of the lower mold piece 32 and the upper mold piece 33. In this case, the electronic device 6 may be arranged only in the lower mold piece 32 in particular. The electronic device 6 arranged in the lower mold piece 32 is not easily displaced due to the action of gravity.

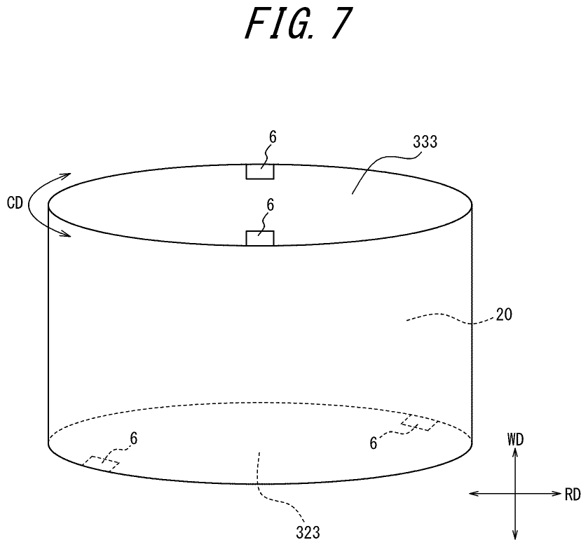

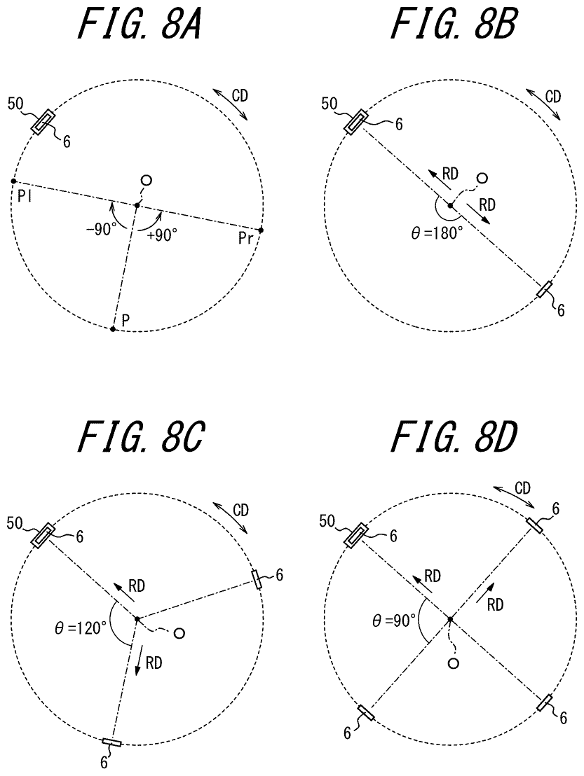

Here, FIG. 7 is a drawing that illustrates an example of the arrangement relationship on the mold circumference of the electronic devices arranged on the lower mold piece side and the upper mold piece side, in the electronic device arrangement process in the method for producing a tire in accordance with one embodiment of the present disclosure. FIGS. 8A to 8D (Hereafter, these may be referred to collectively as “FIG. 8.”) are drawings that respectively illustrates different example of the arrangement relationship on the mold circumference of the serial plate and electronic device arranged on the lower mold piece side and the upper mold piece side, in the electronic device arrangement process in the method for producing a tire in accordance with one embodiment of the present disclosure.

In the electronic device arrangement process, a total of 2 or more electronic device 6 may be arranged in the lower mold piece 32, the upper mold piece 33, the vicinity of the tire outer surface 20o of the tire side portion 28 of the raw tire 20 on the side that comes in to contact with the lower mold piece 32 (Hereinafter, also referred to as “the tire side portion 28 of the raw tire 20 on the lower mold piece 32 side”.), and/or the vicinity of the tire outer surface 20o of the tire side portion 28 of the raw tire 20 on the side that comes in to contact with the upper mold piece 33 (Hereinafter, also referred to as the “the tire side portion 28 of the raw tire 20 on the upper mold piece 33 side”.) so that two or more electronic device 6 are attached to the produced tire 10.

In this case, it is preferable that one or more of the two or more electronic devices 6 are arranged on the lower mold piece 32 side (Including the lower mold piece 32 and the tire side portion 28 of the raw tire 20 on the lower mold piece 32 side. The same applies hereinafter.), one or more of the two or more electronic devices 6 are arranged on the upper mold piece 33 side (Including the upper mold piece 33 and the tire side portion 28 of the raw tire 20 on the upper mold piece 33 side. The same applies hereinafter.), and these two or more electronic devices 6 are arranged so that they are separated from each other by at least 45° in the circumferential direction of the mold with the tire rotation axis centered, when viewed in the direction of the tire rotation axis in the mold 31. In this case, even if a failure or detachment occurs in at least one of the two or more electronic devices 6 in the produced tire 10, there is a high possibility that one of the other electronic devices 6 will remain functional, and this will prevent, for example, the electronic device 6 from being unable to read and write information on the tire 10.

In the example illustrated in FIG. 7, of the total of four electronic devices 6, two electronic devices 6 are arranged in the lower mold piece 32 (in the figure, this is indicated by the tire side portion molding surface 323 of the lower mold piece 32) side, and two electronic devices 6 are arranged in the upper mold piece 33 (in the figure, this is indicated by the tire side portion molding surface 333 of the upper mold piece 33) side. These four electronic devices 6 are arranged so that they are separated from each other by at least 45° (in the illustrated example, they are separated by approximately) 90° in the circumferential direction of the mold when viewed in the direction of the tire rotation axis.

In addition, in the above case, it is preferable that two or more electronic devices 6 are arranged at equal intervals in the circumferential direction of the mold. This arrangement makes it possible, in the produced tire 10, to ensure that any of the electronic devices 6 will remain functional, by leveling out the impact of events that can cause a failure or detachment while the tire is in motion. It will be noted that “arranged at equal intervals in the circumferential direction of the mold” means that the electronic devices 6 may be arranged at equal intervals on either or both the lower mold piece 32 side and the upper mold piece 33 side, regardless of whether the electronic device 6 is located on the lower mold piece 32 side or the upper mold piece 33 side, or that when viewed in the tire rotation axis in the mold 31, the electronic devices 6 may be arranged at equal intervals when viewed on both the lower mold piece 32 side and the upper mold piece 33 side together.

Furthermore, in the above case, it is preferable that the electronic devices 6 arranged on the lower mold piece 32 side and the electronic devices 6 arranged on the upper mold piece 33 side are disposed alternately in the circumferential direction of the mold. According to this arrangement, if an event that causes a failure occurs in one electronic device 6 in the produced tire 10, the other electronic device 6 adjacent to the one in the tire circumferential direction will be located in a different tire half in the tire width direction from the above-mentioned one electronic device 6, so the impact of the event that causes the failure, etc. on the other electronic device 6 can be avoided as much as possible.

In addition, in the above case, it is preferable that the number of electronic devices 6 arranged in the lower mold piece 32 is the same as the number of electronic devices 6 arranged in the upper mold piece 33. In this case, the impact of the event causing the failure can be further leveled out.

In the electronic device arrangement process, it is preferable that at least one or at least two electronic devices 6 is arranged on the circumference of the mold, on at least one of the lower mold piece 32 side or the upper mold piece 33 side. By arranging two or more electronic devices 6 on the circumference of the mold, for example, the overall communication performance of the electronic devices 6 is improved.

FIG. 8 illustrates the arrangement of the serial plate 50 and the electronic device 6 on one side of the mold 31 (For example, the lower mold piece 32 side. The following explanation mainly refers to the lower mold piece 32 side, but the same applies to the upper mold piece 33 side). FIG. 8A illustrates an example where one electronic device 6 is arranged on the circumference of the mold, and FIGS. 8B to 8D illustrate examples where two or more electronic devices 6 are arranged on the circumference of the mold.

Here, in the case of the produced tire 10, the number of the serial 5 provided on the tire half on one side and the tire half on the other side in the tire width direction are each usually one on the circumference of the tire, and therefore, the number of the series plate 50 provided on the lower mold piece 32 side and the upper mold piece 33 side before the tire is vulcanized are also each usually one on the circumference of the mold. Therefore, in the electronic device arrangement process, for example, when arranging two or more electronic devices 6 in total on the lower mold piece 32 side, one of which is an electronic device 6 attached to a serial plate 50 (hereinafter also referred to as “electronic device 6 with serial plate”), and the other of which is an electronic device 6 not attached to a serial plate 50 (hereinafter also referred to as “standalone electronic device 6”), as illustrated in the examples in FIGS. 8B to 8D, it is preferable to arrange the standalone electronic devices 6 so that they are equidistant around the mold, in other words, so that the central angle θ around the tire rotation axis O is equal, starting from the electronic device 6 with the serial plate. In this case, as mentioned above, it is possible to make it even more certain that any of the electronic devices 6 will remain in working order in the produced tire 10, and because the electronic devices 6 are attached at equal intervals on the circumference of the tire, based on the position of the easily visible serial 5, it becomes easier to ascertain the position of the electronic devices 6.

FIG. 8B illustrates an example of two electronic devices 6 arranged at equal intervals on the circumference of the mold so that the central angle θ is 180°, as described above. FIG. 8C illustrates an example of three electronic devices 6 arranged at equal intervals on the circumference of the mold so that the central angle θ is 120°, as described above. FIG. 8D illustrates an example of four electronic devices 6 arranged at equal intervals on the circumference of the mold so that the central angle θ is 90°, as described above.

In addition, in the electronic device arrangement process, it is preferable that when the points on which the center angle seen from an arbitrary point P on the circumference of the mold (of the lower mold piece 32 side or the upper mold piece 33 side) is ±90° are defined as the points Pr and Pl for at least one of the lower mold piece 32 side or the upper mold piece 33 side (see FIG. 8A), a plurality of electronic devices 6 are arranged on the circumference of the mold so that there is always at least one electronic device 6 within the arc Pl-P-Pr that includes the arbitrary point P. In this case, even if the produced tire 10 is a large tire and is stationary in a vertical position at any rotational position, the electronic device 6 will always be within a range of ±90° in the center angle from the lowest point of the stationary tire 10, which improves convenience at the site.

The above description is an example of an exemplary embodiment of the present disclosure, and various changes can be made within the scope of not deviating from the scope of the claims.

For example, in the method for producing a tire described above, in the electronic device arrangement process, the electronic device 6 was mainly placed on the lower mold piece 32 and/or the upper mold piece 33 only, but in addition to or instead of this, in the electronic device arrangement process, the electronic device 6 may be arranged on the side of the raw tire 20, in other words, in the vicinity of the tire outer surface 10o of the tire side portion 8 of the raw tire 20 on the side that comes into contact with the lower mold piece 32 and/or the vicinity of the tire outer surface 10o of the tire side portion 8 of the raw tire 20 on the side that comes into contact with the upper mold piece 33. Even in this case, for example, the electronic device 6 may be arranged in the above-mentioned part of the raw tire 20 by: using the serial plate 50, the elastic member (the one-side elastic member 61a and/or the other-side elastic member 61b) and the electronic device 6, as illustrated in each example in FIG. 6; pre-integrating these; and arranging them on the raw tire 20. In addition, in the above case, in particular, the electronic device 6 may be arranged with at least the serial plate 50, or with the serial plate 50 and the elastic member (the one-side elastic member 61a and/or the other-side elastic member 61b), as illustrated in each example in FIG. 6, in the vicinity of the tire outer surface 10o of the tire side portion 8 of the raw tire 20 on the side that comes into contact with the upper mold piece 33. This is because the serial plate 50 arranged in the upper mold piece 33 may itself be prone to falling from the upper mold piece 33, for example, when the upper mold piece 33 is raised or lowered before and after vulcanization.

The method for producing a tire in accordance with this disclosure and a tire in accordance with the same can be used as a method for producing a tire of any type and as a tire of the same. For example, they can be suitably used for passenger vehicle tires, truck/bus tires, construction/mining vehicle tires, etc., or as a method for producing such tires. In particular, they can be suitably used for the construction/mining vehicle tires, or as a method for producing such tires.

### REFERENCE SIGNS LIST

10 Tire
20 Raw tire
10o, 20o Tire outer surface
1,21 Bead portion
11 Bead core
2,22 Sidewall portion
3,23 Tread portion
4 Carcass
5 Serial
50 Serial plate
51 Identification mark
52 Magnet
6 Electronic device
6a IC chip
6b Antenna
60 Electronic device laminate
61 Elastic member
61a One-side elastic member
61b Other-side elastic member
7 Belt
8,28 Tire side portion
30 Tire vulcanizing apparatus
31 Mold
32 Lower mold piece
33 Upper mold piece
321, 331 Tread portion molding surface
322, 332 Rug groove forming framework
323, 333 Tire side portion molding surface
324, 334 Recesses
34 Shaping unit
35 One-side support
36 Other-side support
80 Bladder
CD Tire circumferential direction
CL Tire equatorial plane
LD Long side direction (Longitudinal direction)
O Tire rotation axis
P, Pl, Pr Point
RD Tire radial direction
SD Short side direction (Transverse direction)
TD Thickness direction
VS Vulcanization space
WD Tire width direction

1. A method for producing a tire to obtain a tire with an electronic device attached to a tire side portion, wherein
a lower mold piece and an upper mold piece are used as a mold for vulcanizing a raw tire, and
the method includes:
an electronic device arrangement process in which the electronic device is arranged in at least one of: the lower mold piece, the upper mold piece, the vicinity of a tire outer surface of the tire side portion of the raw tire on the side that comes into contact with the lower mold piece, and the vicinity of a tire outer surface of the tire side portion of the raw tire on the side that comes into contact with the upper mold piece; and
a vulcanization process in which the raw tire is set in the mold and vulcanized after the electronic device arrangement process.

2. The method for producing a tire as described in claim 1, wherein in the electronic device arrangement process, the electronic device is attached to a component separate from the mold and is arranged in the lower mold piece and/or the upper mold piece via the component separate from the mold.

3. The method for producing a tire as described in claim 2, wherein the component separate from the mold is a serial plate.

4. The method for producing a tire as described in claim 1, wherein in the electronic device arrangement process, the electronic device comprises an elastic member on at least part of a surface of the electronic device.

5. The method for producing a tire as described in claim 1, wherein in the electronic device arrangement process, the electronic device is arranged in the lower mold piece and/or the upper mold piece via an adhesive.

6. The method for producing a tire as described in claim 1, wherein a nominal rim diameter of an applicable rim for the tire is 20 inches or more.

7. The method for producing a tire as described in claim 1, wherein in the electronic device arrangement process, the electronic device is arranged in both the lower mold piece and the upper mold piece.

8. A tire produced by the method for producing a tire as described in claim 1.

9. The tire as described in claim 8, wherein the electronic device is arranged at a position where a depth from the tire outer surface of the tire side portion is 0.1 to 10.0 mm.

10. The method for producing a tire as described in claim 2, wherein in the electronic device arrangement process, the electronic device comprises an elastic member on at least part of a surface of the electronic device.

11. The method for producing a tire as described in claim 3, wherein in the electronic device arrangement process, the electronic device comprises an elastic member on at least part of a surface of the electronic device.

12. The method for producing a tire as described in claim 2, wherein in the electronic device arrangement process, the electronic device is arranged in the lower mold piece and/or the upper mold piece via an adhesive.

13. The method for producing a tire as described in claim 3, wherein in the electronic device arrangement process, the electronic device is arranged in the lower mold piece and/or the upper mold piece via an adhesive.

14. The method for producing a tire as described in claim 2, wherein a nominal rim diameter of an applicable rim for the tire is 20 inches or more.

15. The method for producing a tire as described in claim 3, wherein a nominal rim diameter of an applicable rim for the tire is 20 inches or more.

16. The method for producing a tire as described in claim 2, wherein in the electronic device arrangement process, the electronic device is arranged in both the lower mold piece and the upper mold piece.

17. The method for producing a tire as described in claim 3, wherein in the electronic device arrangement process, the electronic device is arranged in both the lower mold piece and the upper mold piece.

18. A tire produced by the method for producing a tire as described in claim 2.

19. A tire produced by the method for producing a tire as described in claim 3.
